(19) United States
(12) Patent Application Publication
(10) Pub. No.: US 2017/0124159 A1
(43) Pub. Date: May 4, 2017

(54) TECHNIQUES TO PROCESS SUPPORT DATA IN A COMPUTE ENVIRONMENT

(71) Applicant: NETAPP, INC., Sunnyvale, CA (US)

(72) Inventors: AL AMEEN MUTHALIF, Bangalore (IN); Manu Purushotam, Bangalore (IN)

(73) Assignee: NETAPP, INC., Sunnyvale, CA (US)

(21) Appl. No.: 14/927,527

(22) Filed: Oct. 30, 2015

(51) Int. Cl. G06F 17/30; H04L 12/26; H04L 29/08; H04L 12/24

(52) U.S. Cl. CPC G06F 17/30554; H04L 41/12; H04L 43/045; H04L 67/36; H04L 67/10; G06F 17/3056; G06F 17/30424; G06F 17/30958

(57) ABSTRACT

Various embodiments are generally directed an apparatus and method to receive support data for a plurality of clustered storage systems, the support data comprising risks identifying errors for one or more of the plurality of clustered storage systems, generate parsed support data from the support data based on search criteria comprising at least time period information and location information, the search criteria received in a search query, and present the parsed support data in a display on a display device, the display to indicate open and closed risks for one or more clustered storage systems of the plurality of clustered storage systems based on the search criteria.

### TECHNICAL FIELD

Embodiments described herein generally relate to processing support data for one or more clustered systems in a compute environment. In particular, embodiments relate to processing support data based on search criteria and generating a display to present the processed support data.

### BACKGROUND

Clustered storage systems may store and provide information to one or more computing systems in a network, such as a storage area network (SAN) or a network-attached storage (NAS). More specifically, a computing system may write information to a storage system and read information from the storage system over one or more network connections. These clustered storage systems may include storage devices, such as disks, in an array to store the information.

In some instances, these clustered storage systems operate in a mission critical environment and require high availability. Availability is typically measured in percentage, and 100% availability is the best that can be expected. Monolithic systems can be expected to perform 99% of the time. However, 1% downtime translates to 90 hours in a year, or about 3.5 days. For many businesses, 3.5 days without information system support would be either catastrophic, or at least very expensive. As a general rule, two “9s,” or 99% translates to a week of downtime. Three “9s” equates with days, four “9s” with hours and five “9s” with minutes. Fault-tolerant high availability system can improve reliability to 99.999%, or five minutes a year. At this level of system reliability, it is far more likely that extrinsic factors will interrupt service. To achieve this high availability reliability a great deal of effort goes into identifying potential problems, such as a computer bug, before they cause a problem. Managing and tracking these potential problems can be an arduous task.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1A illustrates an example embodiment of a compute system.

FIG. 1B illustrates an example embodiment of a support system.

FIG. 2A illustrates an example embodiment of a logic flow to process support data.

FIG. 2B illustrates an example embodiment of a logic flow to process a search query and search criteria.

FIG. 2C illustrates an example embodiment of a logic flow to process a risk trend.

FIG. 2D illustrates an example embodiment of a logic flow to process information for display.

FIG. 3A illustrates an example of a display to specify search criteria.

FIG. 3B illustrates a second embodiment of a display to specify search criteria.

FIG. 3C illustrates a third example of a display to specify search criteria.

FIG. 4A illustrates an example of a display to present risks.

FIG. 4B illustrates a second example a display to present risks.

FIG. 4C illustrates an example of a display to present risk trends.

FIG. 5 illustrates an exemplary embodiment of a logic flow.

FIG. 6 illustrates an exemplary embodiment of a computing system.

FIG. 7 illustrates an embodiment of a first computing architecture.

### DETAILED DESCRIPTION

Various embodiments are generally related to one or more methods, techniques and systems to process support data in a compute environment. The support data includes system configuration information and risk information associated with one or more clustered storage systems. The system configuration information may include hardware platform information, software version information, customer information, location information, and so forth. The risk information may identify one or more known risks or problems that may affect the clustered storage systems. A risk may be associated with a particular clustered storage system based on system configuration information including the hardware platform and software version.

Embodiments include techniques and systems to enable a user to input search criteria to generate a search query, parse the support data based on the search query, generate search results including the parsed support data, and present the search results and parsed support data in one or more formats. Moreover, a user may enter search criteria and search results may be generated and presented in real-time.

A user may enter any combination of search criteria to generate search results. For example, a system may receive search criteria including a time period, a location, a hardware platform, and a software version. The system may use the search criteria to parse support data and retrieve all the configuration information and risk information associated with clustered storage systems based on the entered time period, location, hardware platform, and software version. The system may generate a search result including the parsed support data that may be presented to a user in a display on a display device. In some embodiments, the parsed support data may be presented in one or more of a graph format and a table format. In some instances, a graph format may provide a general overview of the parsed support data and the table format may provide a detailed overview of the parsed support data. Embodiments are not limited to this example, as will be discussed below. Moreover, these and other details will become more apparent with following description.

Various embodiments also relate to apparatus or systems for performing these operations. This apparatus may be specially constructed for the required purpose or it may include a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

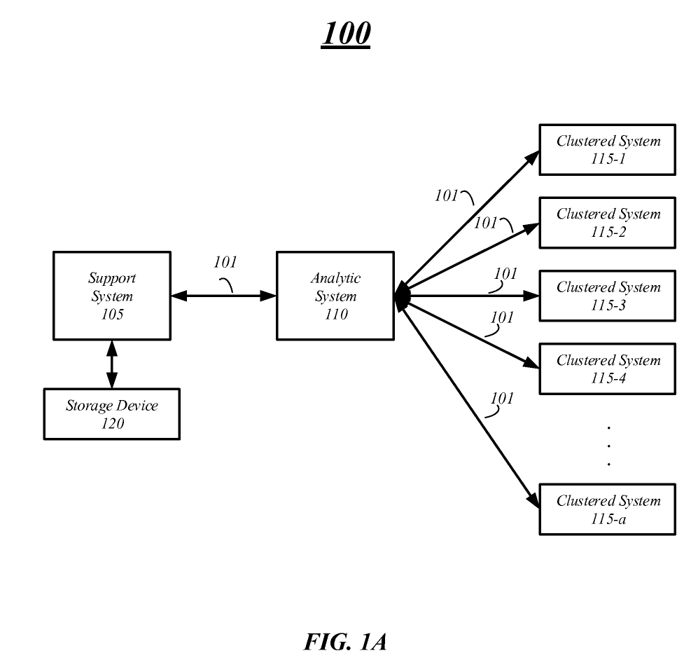

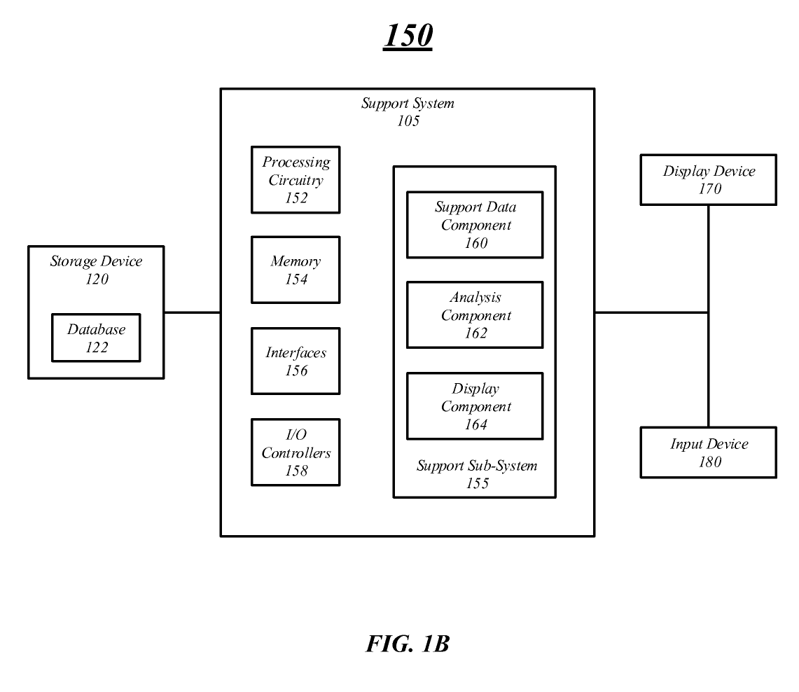

FIG. 1A illustrates a general overview of an compute system 100 including a plurality systems such as a support system 105, an analytic system 110, and one or more clustered storage systems 115-1 through 115-a, where a may be any positive integer. In embodiments, these systems may be coupled with one another via one or more wired or wireless communication links 101. These communication links 101 may also include any type of intermediate networking hardware, such as routers, switches, converters, translators, firewalls, access points, and so forth. Embodiments are not limited in this manner.

In embodiments, the systems 105, 110, and 115 include any number of computing devices, such as any type of computer or any type of server. Further, the systems 105, 110, and 115 may communicate any type of information between each other via the communication links 101. For example, support data may be communicated between the systems 105, 110, and 115. The support data may include a system configuration of each of the clustered storage systems 115, may be periodically or semi-periodically captured by the analytic system 110, and communicated to the support system 105. The system configuration information for each clustered storage system 115 can include a location, a customer identification, a serial number, a host name, a platform identification, and a software version. The location may be broken down into further location categories including a region, a service area, and a country. For example, the region may be the Pacific region, the service area may be Indo-China, and the country may be China. As will be discussed in more detail, this information may be used by the support system 105 to provide risk information by a specific location. In some embodiments, the system configuration information may also provide run-time analytics for a clustered storage system. For example, the system configuration information may identify an uptime, a time since last failure or outage, encountered errors, and so forth for a clustered storage system.

The support data may also include risk information identify risks or potential problems that may cause one or more clustered storage system 115 to experience an error under certain conditions. A risk may include any type of error or bug that effects hardware and/or software of a clustered storage system 115. In embodiments, the risk information may be determined, collected, received, and retrieved by the analytic system 110. In embodiments, the risk information may be associated with each of the clustered storage system 115 based on a hardware platform and/or a software version. More specifically, risks may be determined to effect specific hardware platforms and may be associated with each clustered storage system 115 having that specific hardware. Similarly, risks may be software bugs that effect specific software versions and the risks may be associated with clustered storage systems 115 operating the specific software version. The risk information in the support data may also indicate whether a specific risk is opened or closed, e.g. fixed or not fixed. In embodiments, the analytic system 110 may store the support data including the risk information and the system configuration information in a database system.

In embodiments, the support data including the system configurations and the risk information is communicated to the support system 105 via the one or more communication link 101 as one or more packets, for example. The analytic system 110 may communicate the support data in a particular format, such as in a text file having a comma-separated values (CVS) format. Thus, the analytic system 110 may retrieve the support data, convert or transform the support data to the CVS format, and communicate the support data to the support system 105. However, embodiments are not limited in this manner. For example, the analytic system 110 may communicate the support data in a different format, such as a database format, as one or more database communication messages in a structured query language (SQL) format or any other database format.

Further, the analytic system 110 can communicate the support data on a periodic, semi-periodic, or non-periodic basis. For example, the analytic system 110 can communicate the support data on a daily, weekly, or monthly basis. In another example, the analytic system 110 may communicate the support data when certain amount is gathered, such as 1 Gigabyte, 50 Gigabyte, or 100 Gigabyte. Embodiments are not limited in this manner.

The support system 105 may receive the support data and store the information in a coupled storage device 120. The storage device 120 may be any type of storage device such as a non-volatile storage unit including a hard disk drive, a secure storage device (SSD), a flash memory, and so forth. In some embodiments, the storage device 120 may be a database system including a number of non-volatile memory devices and the support data may be saved in a database format, such as an SQL format. Embodiments are not limited in this manner and the storage device 120 may be in a different database format, such as a “NoSQL” format including Cassandra, Hadoop, Voldemort, Dynomite, and others.

In instances, the support system 105 converts the support data from a particular format in which it was received to a format for the storage device 120. For example, the support system 105 may receive the support data in a CVS format and convert the support data to a database format for storage on the storage device 120. In embodiments, the support data may be considered “big data” and may pose big data problems with processing large amounts of data. Thus, as will be discussed in more detail below, embodiments are directed to solving these and other issues. For example, the support data may be accessed and presented to a user based on search criteria. Further, the support data may also be processed in “real-time” for analytics projects. For example, the support system 105 may process the support data in real-time from distributed sources, such as the storage device 120, by applying queries to the support data while receiving search criteria to present the support data in a display on a display device.

FIG. 1B illustrates an example embodiment of a system 150 including a support system 105 coupled with a storage device 120, a display device 170 and an input device 180. The support system 105 may be the same as the liked name system in FIG. 1A. In embodiments, the support system 105 includes processing circuitry 152, memory 154, interfaces 156, and, an Input/Output (I/O) controllers 158. The support system 105 also includes a support sub-system 155 having a number of components to process the support data and other information. The support sub-system 155 includes a support data component 160, an analysis component 162, and a display component 164.

The processing circuitry 152 which may include one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processing circuitry, processor or processing circuit on a single chip or integrated circuit. The processing circuitry 152 may be connected to and communicate with the other elements of the support system 105 including the memory 154, interfaces 156, I/O controllers 158 and the components.

The support system 105 also includes memory 154 that can be implemented using any machine-readable or computer-readable media capable of storing data, including both volatile and non-volatile memory. In some embodiments, the machine-readable or computer-readable medium may include a non-transitory medium. The embodiments are not limited in this context. The memory 154 can store data momentarily, temporarily, or permanently. The memory 154 stores instructions and data for system 105. The memory 154 may also store temporary variables or other intermediate information while the processing circuitry 152 is executing instructions. The memory 154 is not limited to storing the above discussed data; the memory 154 may store any type of data.

The support system 105 may also include one or more interfaces 156 which may enable the support system 105 to communicate over a network environment including one or more communication links 101. In some embodiments, the interfaces 156 can be a network interface, for example. The support system 105 also includes I/O controllers 158 which can include circuitry to communicate with devices, such as storage device 120, display device 170, and input device 180. The I/O controllers 158 can include a universal serial bus interface (USB), a Firewire interface, a Small Computer System Interface (SCSI), a parallel port interface, a serial port interface, a DisplayPort interface, high-definition multimedia interface (HDMI) or any other device to enable the support system 105 to exchange information over a wired or wireless links.

In embodiments, the support sub-system 155 processes and communicates support data, processes search queries, and generates and communicates display information. For example, the support sub-system 155 may receive support data including system configuration information and risk information and store the support data in a database 122 on storage device 120. Further, the support sub-system 155 may receive a search query including one or more search criteria and perform a parse operation based on the search query to gather a subset of the support data, e.g. parsed support data. The parsed support is then used to generate a display that can be presented on a display device. The display may be a table or a graph representation of the parsed support data. As will be discussed in more detail below, the support sub-system 155 parses the support data in any manner based on the search query and search criteria. Thus, a user can cause the generation of a display illustrating risks associated with clustered storage system 115 based on one or more search criterion including but not limited to, a location, a customer identification, a risk level, a service level, a system identification or hardware platform, a software identification or version, a serial number, a host name, a time frame or period, and so forth. Further, the support sub-system 155 may receive search queries including search criteria in real-time and cause the display to be updated in real-time. Embodiments are not limited in this manner.

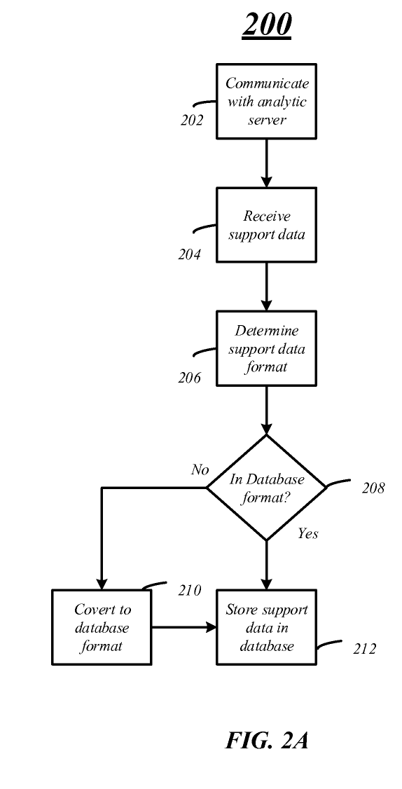

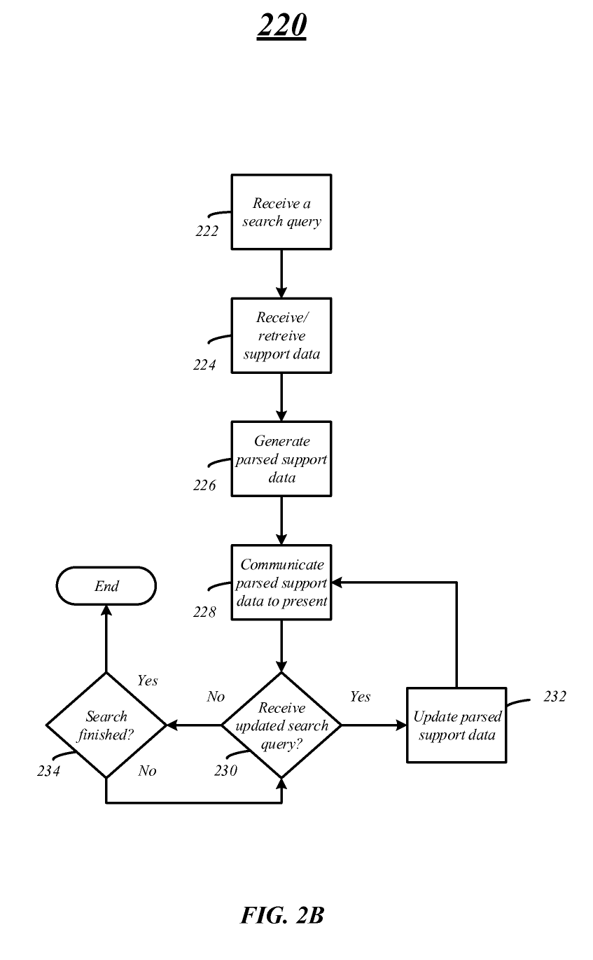

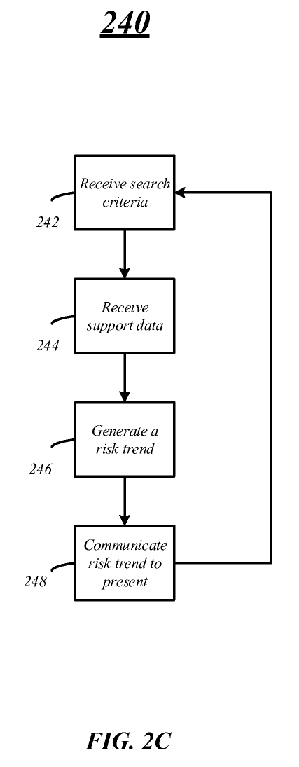

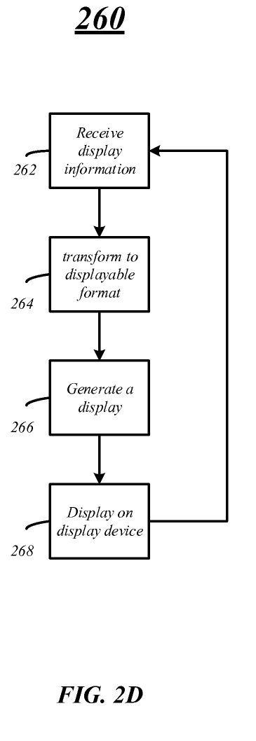

As previously discussed, the support sub-system 155 includes a support data component 160 to process support data. For example the support data component 160 can receive support data from one or more other systems, store the support data in a storage device, and retrieve the support data from the storage device for further processing and parsing. In embodiments, the support data component 160 includes a support data processing routine to process the support data. FIG. 2A illustrates one possible logic flow 200 that may occur during operation of a support data processing routine processed by the support data component 160 and processing circuitry 152. Thus, reference is now made to FIG. 2A.

In embodiments, the logic flow 200 may include the support data component 160 communicating with an analytic server of the analytic system 110 at block 202. More specifically, the support data component 160 may communicate a request for information to the analytic system 110 to receive support data. The request may be any type of request communicated in a number of packets over a communication link. At block 204, the support data component 160 may receive support data from the analytic system 110. The support data may include system configuration information and risk information. As mentioned, the system configuration information may include system configurations for clustered storage systems. The risk information may include identified potential problems that may affect at least one of the clustered storage systems. Further, the risk information may be associated with particular clustered storage systems. For example, each risk may be associated with each clustered storage system that it affects. Thus, the system data may be a list or table of clustered storage systems and associated risks. In embodiments, the support data may be communicated to the support system 105 in a particular format, such as a CVS or database format. Embodiments are not limited in this manner and support data may be communicated in a database format.

At block 206, the support data component 160 may determine a format for the support data. As mentioned, the support data may be in a CSV format, a database format or another format. The format may be determined by reading the communicated support data including headers and other information indicating a format type. Other techniques can be used to determine a format for the communicated support data, embodiments are not limited in this manner. Further and at decision block 208, a determination is made as to whether the support data is a database format or a different format. If the support data is in a database format, the support data may be stored in a database 122 on the storage device 120 by the support data component 160 at block 212. If the support data is not in a database format at decision block 208, the data may be converted to a database format at block 210 by the support data component 160 and then stored in a database 122 on the storage device 120. Further, the support data is typically stored in a format that can be read by other components of the support sub-system 155 including the analysis component 162 and the display component 164.

Referring back to FIG. 1B, in embodiments, the support sub-system 155 may also include an analysis component 162 to process information and support data based on search queries and search criteria. More specifically, the analysis component 162 uses search criteria from search queries to parse the support data and prepare the parsed support data for presentation. In embodiments, the analysis component 162 includes an analysis routine to process and analyze support data. FIG. 2B illustrates one possible logic flow 220 that may occur during operation of an analysis routine processed by the analysis component 162 and processing circuitry 152. Thus, reference is now made to FIG. 2B.

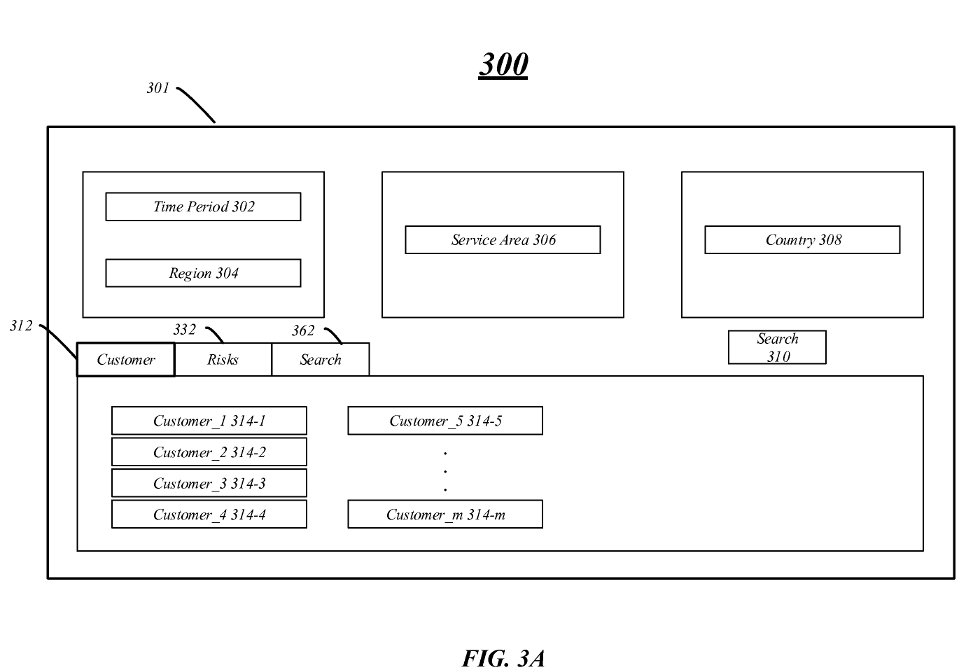

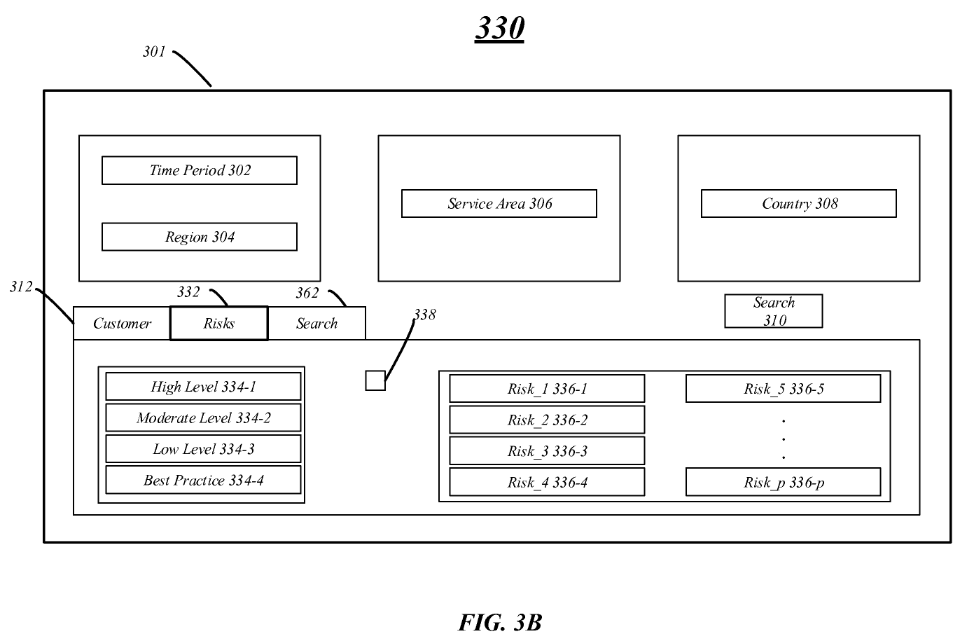

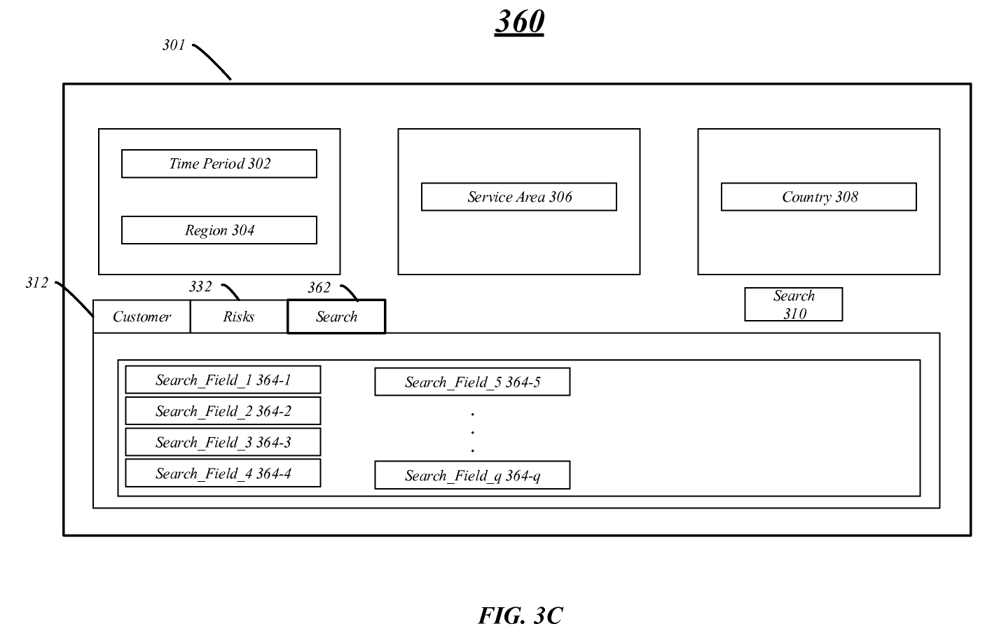

At block 222, the analysis component 162 receives a search query that includes one or more search criterion to analyze and parse the support data. The search query may be user generated via an input, such as input device 180 which may include a keyboard, mouse, touch-pad or any other input device. For example, a graphical user interface (GUI), such as one or more of the displays illustrated in FIG. 3A-3C, may be presented to a user and a user may enter search criteria in one or more fields of the GUI via a mouse, a touchpad/screen, and/or keyboard to generate a search query. In another example, the search query may be a computer generated query based on a predetermined search configuration setup. More specifically, a search configuration may be configured and executed on a periodic/semi-periodic basis to generate a search result or parsed support data to present to a user. In some embodiments, the search query may be received as a batch file including one or more search criterion.

The search criteria is generally used to parse the support data to provide risk information based on the search criteria. The search criteria can include time period information to specify a specific time period to search the support data and location information to search a specific location for the support data. Other possible search criteria include a customer identification to search by a specific customer in the support data, a risk level to search by a specific risk level, a service level to search by a specific/support service purchased by a customer, a system identification to search by a specific hardware platform, a software identification to search by a particular software version. In some embodiments, the search criteria may also include searching by open risks, closed risks, and all risks (open and closed). Embodiments are not limited in this manner and other search criteria may be used to parse the support data.

Note that the search query may include any combination of the above-mentioned search criteria. Moreover, the search query can include more than one search criteria of the same type. For example, the search query may include a plurality of dates, locations, customer identifications, serial numbers, and so forth. Similarly, the search query may include only a single search criterion of one or more types. Embodiments are not limited in this manner.

At block 224, the analysis component 162 receives or retrieves the support data from the storage device 120. In embodiments, the analysis component 162 may retrieve the desired support data by issuing one or more database queries. For example, one or more database queries may retrieve support data based on a search query including time period information and location information. In another example, one or more database queries may retrieve support data based on search query including one or more of a customer identification, a risk level, a service level, a system identification, and/or a software identification. Any combination of search criteria may be used to retrieve the support data from a database 122 on the storage device 120.

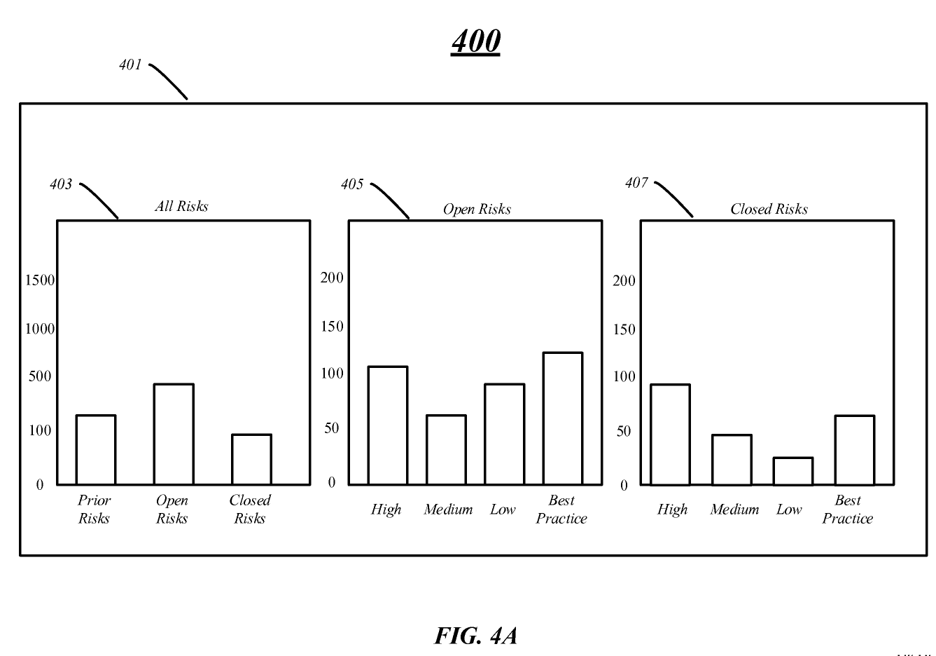

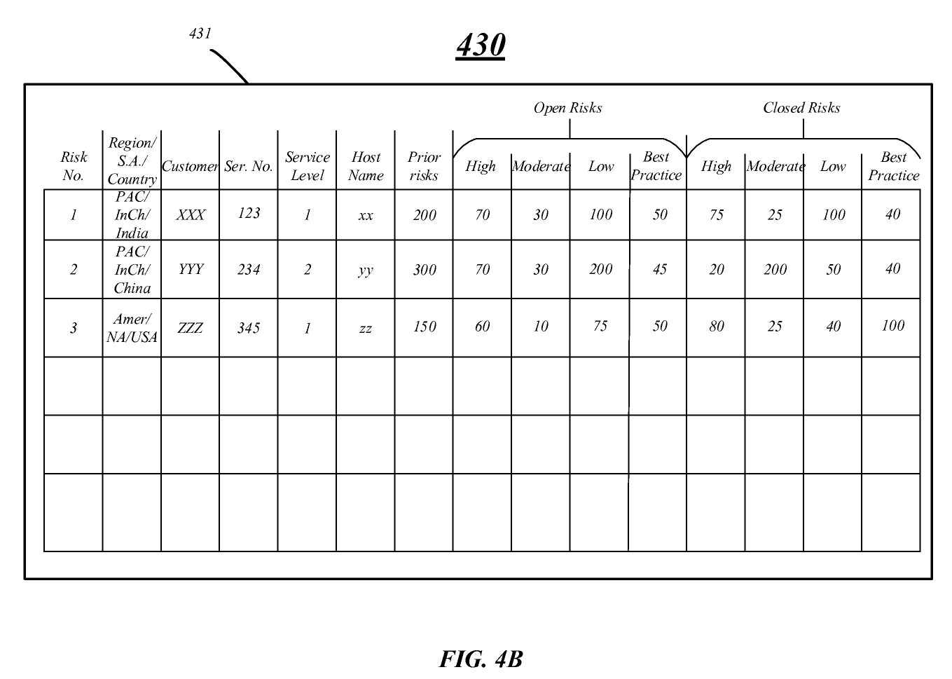

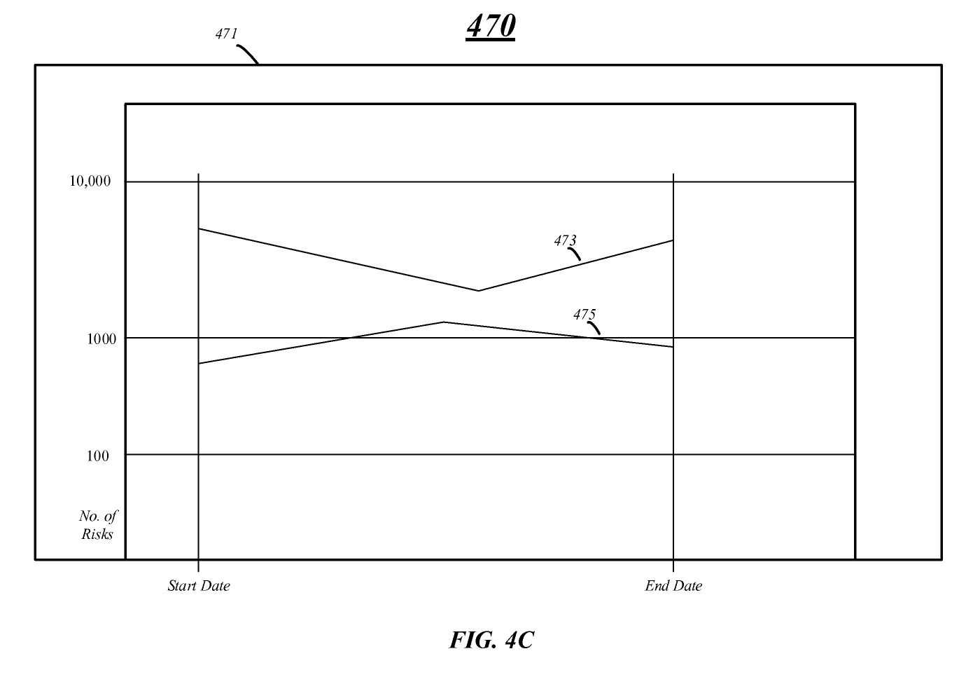

At block 226, the analysis component 162 may generate parsed support data. The parsed support data is a subset of the support data parsed in accordance with the search query and the one or more search criterion. In embodiments, the analysis component 162 may generate the parsed support data by combining the information retrieved from the database 122 received from one or more database queries conducted at block 224. The parsed support data is used to generate a search result that can be presented in a display on a display device. For example, the parsed support data may be used to generate a table and/or one or more graphs to be presented in the display, as illustrated in FIGS. 4A-4C.

Further and at block 228, the analysis component 162 communicates the parsed support data to the display component 164 to generate the display and present the display on a display device 170. The parsed support data may be presented in a display on a display device, as will be discussed in more detail below.

At decision block 230, the analysis component 162 determines whether an updated search query including one or more different search criterion has been received. Further and at block 232, the analysis component 162 component updates the parsed support data by retrieving support data from the database 122 if an updated search query is received. The updated parsed support data may be communicated for presentation at block 228 by the analysis component 162. In embodiments, any number of search queries with one or more search criterion may be received and processed by the support system 105 in real-time. If at block 234 a search is complete, the logic flow 220 may end.

With reference to FIG. 1B, in embodiments, the analysis component 162 can also process and determine risk trends. A risk trend indicates whether open risks and closed risks are increasing or decreasing over time. For example, a risk trend may indicate that open risks are increasing over time due to the rate of new risks generated or discovered is greater than the rate of known risks being fixed. Similarly, the risk trend may indicate that open risks are decreasing over time due the rate of new risks generated or discovered is less than the rate of known risks being fixed. The risk trend for closed risks may be indicated in a similar manner and generally is the opposite of the risk trend for open risks.

A risk trend may be determined at a support system level showing an overview of all opened and closed risks over time. Additionally, a risk trend may be limited and based on search criteria to illustrate a trend for a specific period of time, location, customer, serial number, platform identification, software identification, support level, risk level, and combination thereof. A risk trend can be updated in real-time as new support data and/or search criteria is received. FIG. 2C illustrates logic flow 240 that may occur during an operation of a trend routine performed by the analysis component 162. Thus, reference is now made to FIG. 2C.

At block 242, the analysis component 162 receives search criteria. In embodiments, the search criteria may be received in a search query generated by a user or by a computer. The search criteria may be the same criteria used to generate a table or graphical display of a search result, as discussed with respect to FIG. 2B, or may be received in a separate search query. Further, the analysis component 162 retrieves the support data from the database 122 at block 244. The support data may retrieved, as previously described above, by executing one or more database queries based on the received search criteria. In some instances, the retrieved support data may be considered parsed support data.

In embodiments, the analysis component 162 may generate a risk trend, which may include information displayable in a display on the display device 170. In one example, the risk trend may include information indicating open and closed risks over a period of time. In some instances, the risk trend may include information to display the open and closed risks in a line graph format, as will be discussed in more detail below with respect to FIG. 4C. At block 248, the risk trend may be communicated to the display component 164 by the analysis component 162 for presentation on the display device 170. Embodiments are not limited in this manner.

With reference to FIG. 1B, the support sub-system 155 also includes a display component 164, as previously mentioned. The display component 164 may receive information from the analysis component 162 and display the information on the display device 170 in a display, as illustrated in FIGS. 4A-4C. In some instances, the display component 164 displays parsed support data including risk information in a table format or a graph format. The table format may include any number of rows and columns where each row corresponds with a particular instance of a risk for a clustered storage system, and each column includes information associated with each of the risks. The graph format may illustrate the risks based on search criteria in as a bar graph format. A bar graph of the risks may display all risks, including prior risks, open risks and closed. Additional bar graph displays may be generated to provide further detail including the priorities of open risk and closed risks, for example.

The display component 164 can also display a risk trend or risk trend information in a display on the display device 170. As previously mentioned, the risk trend may be displayed in a graph format, such as a line graph. The line graph may illustrate a number of risks (open and closed) over a period of time. Thus, a line associated with open risks slopes down over time may indicate that risks are being fixed or resolved faster than they are being discovered. On the other hand, a line associated with open risks sloping upwardly over time may indicate that risks are being resolved slower than they are being discovered. A similar line in the line graph may be illustrated for closed risks and typically will slope in the opposite direction of the line associated with the open risks. Embodiments are not limited in this manner.

FIG. 2D illustrates one possible logic flow 260 that may occur during operation of a display routine processed by the display component 164 to present information. Thus, reference is now made to FIG. 2D.

At block 262, the display component 164 receives information to present in a display on a display device 170. For example, the display component 164 may receive parsed support data from the analysis component 162 to present open and closed risks in a table format or a graph format. The display component 164 may also receive risk trend information from the analysis component 162 to present in a graph format. In some instances, the parsed support data and the risk trend information may be received in a “raw” format such as in a CVS file format from the analysis component 162. This format may not be in a presentable form. Thus, at block 264, the display component 164 transforms the parsed support data and/or the risk trend information into a displayable format. For example, the display component 164 may transform the parsed support data in the CSV format into a table format by populating a table with the information. In another example, display component 164 can generate a graph format or representation of the parsed support data using the CSV format. Similarly, the display component 164 can transform the risk trend data into a displayable format, such as in a table or a graph. Embodiments are not limited in this manner.

At block 266, the display component 164 may generate a display to present on the display device 170. More specifically, the display component 164 may utilize a graphics processing technique to generate a table or a graph to present the parsed support data and/or the risk trends for opened and closed risks based on search criteria. Further and at block 268, the display component 164 communicates the display to the display device 170 for presentation. The display may be communicated utilizing a graphics processing engine and a frame buffer in one or more frames over a bus or interface, such as an HDMI or DisplayPort interface. In some embodiments, the display may be communicated wirelessly using a wireless display technology.

Generally, the display may be updated each time search criteria is communicated and processed by the support system 105 or when new support data is received from the analytic system 110. As mentioned, a user may be presented with a GUI interface to enter search criteria and to generate a search query used by the support system 105 to parse support data and provide risk information to the user. Any combination of search criteria may be entered by the user to generate a unique display of the support data based on the user's inputs. The display may be presented in a table format and a graphic format and may be updated in real-time as search criteria is changed, added or removed to parse the support data.

FIG. 3A illustrates an example embodiment of a display 300 to present on a display device, such as display device 170 for a user to enter search criteria. Display 300 includes a graphical user interface (GUI) 301 having a number of areas to enable a user to enter the search criteria. In some instances, the GUI 301 includes tabs, such as the customer tab 312, the risks tab 332, and the search 362 to present different types of search fields to a user. In embodiments, the search fields may enable a user to enter search criteria. The fields may be text drop down menus, text input boxes, radial selection inputs, a selection list, and so forth. Each of the fields may enable a user to select any number of search criteria of a specific type. For example, a user may enter or select a plurality of locations for use as search criteria. In some embodiments, a user open a file selection box and select a particular file to load a “batch” grouping of one or more of the search criteria.

In display 300, the GUI 301 includes a time period field 302 and a region field 304 to enable a user to enter one or more specific time periods and specific regions. A time period entered into the time period field 302 can be any unit of time, including a number of hours, days, weeks, months, and so forth. In some instances, the time period can be a range of time, having a start time and an end time. For example, user may enter a start date and an end date, such as Oct. 13, 2015-Oct. 20, 2015. Embodiments are not limited to a specific format to enter the time period.

The region field 304 enables a user to enter one or more regions to parse the support data. The region field 304 may enable a user to enter a region or location at a high level or wide area. For example, a region may be a Pacific region, a European Region, a Middle East region, an America region, and so forth. Enabling a user to parse the support data by region may provide a high level overview of open and closed risks for specific regions.

In embodiments, the location may further be refined by utilizing a service area field 306 to enter a service area and country field 308 to enter a country. The service area may be a smaller area within a specific region, and the country may be an even smaller area with in the service area. Moreover, a region may include a number of services areas, and each of the service areas may include a number of countries. Thus, when a user selects or enters a region in the region field 304 the service area field 306 may be populated with service areas within the selected region. Similarly, the country field 308 may be populated with specific countries within a chosen service area. In the case where more than one region is selected, service areas and countries within each of the more than one regions may be populated in the service area field 306 and the country field 308. Similarly, the country field 308 may be populated with a number of countries from multiple service areas. Embodiments are not limited in this manner.

The service area may be defined as an area of service that is smaller than a region, but larger in a country. However, in some instances, the service area may be a country or a region. The service area may be user defined as an area that is serviced by a specific business unit or support unit. Embodiments are not limited in this manner. Examples of a service area may include Indo-China, Western Europe, Eastern European, Northern Africa, Middle East, North America, Central America, South America, and so forth. Further, a country may be the United States, France, Germany, China, India, Japan, South Korea, Brazil, and so forth. A country may not be limited to these examples.

The service area and country may allow as user to see a more granular picture of the open and closed risks compared to searching by a region. In some embodiments, a user may be able to search by a smaller area, such as by city. Embodiments are not limited in this manner.

In display 300, the customer tab 312 is selected and displayed within the GUI 301. The customer tab 312 enables users to select specific customers to parse to the support data to provide risk information. Display 300 illustrates a list of customers 314-1 through customer 314-m, where m may be any positive integer. Each customer 314 may have one or more clustered storage systems 115. Thus, support data for each of a selected customer's clustered storage system(s) 115 may be provided and presented to a user. Although FIG. 3A illustrates the customers 314 in a list format, embodiments are not limited in this manner. The customers 314 may be presented to a user in any type of selection or entry format. In some embodiments, the customer tab 312 may include a filter field (not shown) to enable a user to enter a customer to filter the list by.

FIG. 3B illustrates an example embodiment of a display 330 having GUI 301 with the risks tab 332 selected. In the illustrated display 330, the risks tab 332 is selected and displayed in the GUI 301. The risks tab 332 enables a user to select risk levels 334-1 through 334-5 and specific risks 336-1 through 336-p, where p may be any positive integer. The risk levels include a high level 334-1, a moderate level 334-2, a low level 334-3, and a best practice level 334-4. A high level risk is the most serve risk or may cause the most damage, downtime, and so forth. A moderate level risk is a middle level risk and may cause less damage/downtime than the high level risk and more damage/downtime than a low level risk. A low level risk may cause the least amount of damage/downtime. The best practice risks are the risks that may have the highest “return on investment” in fixing. For example, a best level risk may be a risk that affects the largest number of systems.

A user may select one or more of the risk levels to parse the support data. For example, the high level 334-1 and the moderate level 334-2 may be selected and support data associated with these risk levels may be parsed and presented on a display. In another example, the low level 334-3 may be selected and support data associated with the low risk level may be parsed and presented on a display. Any combination and number of risk levels may be selected to parse the support data.

The risk tab 332 also enables the selection of individual risks or known potential problems to parse the support data. In the illustrated example, risk tab 332 includes a number of risks 336-1 through 336-p, where p may be any positive integer. Each of these risks 336 may be a name or identifier of a known potential problem and a user may select one or more of the risks to parse the support data. For example, a user may select the first risk 336-1 and support data associated with the first risk may be parsed and presented on a display. In another example, the first risk 336-1 and second risk 336-2 and all support data associated with these risks may be parsed and presented on a display. Any combination of risks 336 may be selected to parse the support data and present on a display.

In some embodiments, the risk tab 332 may include a check box or selection box 338 to enable a user to limit risks associated with a selected customer(s) 314 on customer tab 312. In another words, when selection box 338 is selected only risks 336 for those previously selected customers are presented to a user in the GUI 301. This may be accomplished by the display component 164 making a number of database queries based on the selected customers to retrieve information and risks associated with those customers from the database 122. In some instances, the display component 164 have previously retrieved support data and may parse the support data to present the information and risks in the GUI 301 without making additional database queries. Embodiments are not so limited.

FIG. 3C illustrates an example embodiment of a display 360 having GUI 301 with the search tab 362 selected. The search tab 362 may include a number of search fields 364, which may be entry boxes, drop down menus, selection button, file selection boxes, and forth, as previously discussed. The search tab 362 can include any number of search fields 364-1 through 364-q, where q may be any positive integer. Each of the selection fields 364 enables a selection of a specific search criteria for use in parsing the support data. Examples of selection fields 364 include a customer identification, a service level, a system identification, a software identification, a serial number, a host name, a BURT signature, a BURT identification, and so forth.

Each of the selection fields 364 can be individually selected to enable a user to parse the support data with any combination of search criteria. In some instances, check boxes associated with each of the selection fields 364 may be presented and enable a user to select which of the selection fields 364 to sue when generating a search query. Further, the selection fields 364 may enable a user to select more than one search criteria of a specific type. In some instances, the information presented in the selection fields 364 may be based on previous selections of search criteria. For example, embodiments may include a check box or a selection box to enable a user to only populate the selection fields 364 with information associated with a customer 314 selected on the customer tab 312. In another example, the selection fields 364 may only present information associated with selection criteria selected in a time period field 302, region field 304, service area 306, country 308, and so forth. Moreover, as additional search criteria is selected any of the fields may be updated based on a selected search criterion.

In embodiments, a user may select any number of search criteria on each of the tabs and specify a time period and location information to generate a search query to parse the support data. For example, a user may specify a time period in the time period field 302, specify a region, a service area, and a country in their corresponding fields 304, 306 and 308, select a specific customer from a customer field 314, select a specific risk level from a risk level field 334 and enter additional search criteria in search fields 364. A search query is generated based on the selections and used to parse the support data to present in a display. Any combination of search criteria may be specified to parse the support data. Further, search criteria may be added or removed to update the parsed support data in real-time. Embodiments are not limited in this manner.

In embodiments, each of the displays 300, 330, and 360 may be controlled and presented by the display component 164. The display component 164 may generate the displays using a hypertext markup language (HTML), for example, and present selection criteria to a user in a web browser. In some instances, the display component 164 may make one or database queries to retrieve search criteria from the database 122 to populate each of the fields of the displays 300, 330, and 360. The search criteria may be parsed and presented in the appropriate fields based on one or more tags, for example. In embodiments, the display component 164 may make additional database queries to retrieve search criteria based on one or selections in one or more of the fields. For example, a user may select a region in the region field 304 and the display component 164 may perform one or more database queries to gather service areas and countries within the selected region. The service areas and countries may then be populated in their respective fields. Embodiments are not limited in this manner. For example, the display component 164 may initially retrieve all of the possible search criteria and then parse the presented search criteria in fields based on a selection.

In some embodiments, the displays 300, 330, and 360 may include a search button 310, which may enable a user to generate a search query based on all of the previously selected search criteria. In other words, a user may select search criteria presented in the displays 300, 330, and 360 and then press the search button 310 to generate the search query that may be received by the analysis component 162, for example.

FIG. 4A illustrates an example embodiment of a display 400 having GUI 401 to present parsed support data in a graph format. The display 400 is generated based on a search query having search criteria and presents information including risk information in bar graphs. The risk information may include open and closed risks associated with search criteria. In some embodiments, the information presented in the GUI 401 may be considered a summary report since it may limited to an amount of detail for showing.

In bar graph area 403, all risks associated with selected search criteria may be presented to a user in display 400 in a bar graph format. More specifically, the prior risk bar indicates a total number of risks opened prior to the selected time period, the open risks bar indicates a total number of open risks, and the closed risk bar indicates a total number of closed risks during the time period.

Bar graph areas 405 and 407 provide a further level of detail of the open risks and closed risks, respectively. More specifically, bar graph area 405 illustrates open risks broken down by risk level and bar graph area 407 illustrates closed risks broken down by risk level. Although not drawn to scale, the total number of risks illustrated in bar graph area 405 equals the number of open risks in bar graph area 403 and the total number of risk illustrated in bar graph area 407 equals the number of closed risk in bar graph area 403. Embodiments are not limited to displaying the parsed support data in a bar graph and different types of graph formats may be used such as pie charts, sideways bar graphs, line graphs, circular graphs, and so forth. Further and as will be discussed in more detail below, the parsed support data may be presented in a table format. In some embodiments, the search results may be presented in a number of different ways, including by hardware platform, by software version, by contract, by partner direct, or any combination of search criteria. Embodiments are not limited in this manner.

FIG. 4B illustrates an example embodiment of a display 430 having a table 431 to present parsed support data in a table format. The display 400 is generated based on a search query having search criteria and presents information including risk information in a table. The risk information may include open and closed risks associated with the search criteria. In embodiments, the table 431 may be presented with GUI 401 to present parsed support data in a common display. On the other hand, the GUI 401 and table 431 can be presented in different displays. In some embodiments, the table 431 may be considered a detailed report because it is able to present a large amount of detail.

The table 431 includes any number of rows and columns for presenting parsed support data. Each row corresponds with a particular instance of a risk for a clustered storage system, and each column includes information for each of the risks and the clustered storage systems. The columns may include a risk number, a location (region/service area, country), a customer identification, a serial number, a service level, a host name, prior risks, open risks, and closed risks. As similarly discussed above, open risks and closed risks can be further defined by risk levels including high, moderate, low and best practice.

FIG. 4C illustrates an example embodiment of a display 470 having a graph representation 471 to present a risk trend over a period of time. The graph representation may be a line graph having a number of risks on a right hand side and a time period having a having a start date and an end date on the bottom. The graph representation 471 is generated based on a search query having search criteria and presents information including risk information in a graph format, e.g. a line graph.

In the illustrated example, the closed risks are illustrated by line 473 and the open risks are illustrated by line 475. As can be seen as the number of the open risks increase when the number of closed risks reduces over a period of time. Further, the number of open risks reduce when the number of closed risks increases over time. Thus, the risk trend of closed risks generally has an inverse relationship with the risk trend of open risks. In FIG. 4C, the risk trend may be for the total number of risks based on search criteria. However, embodiments are not limited in this manner and a risk trend may be generated for each risk at a particular risk level. In other words, the graph representation 471 may present the risk trend for only high risks, moderate risks, low risks, or a combination thereof.

In some embodiments, the search results, may be exported as one or more files to save the information in memory. For example, a search query may be generated to parse support data and generate search results. The search results may be saved or stored in a database, exporting in a CVS file format, and/or communicated to another device via one or more communication links. Embodiments are not limited in this manner.

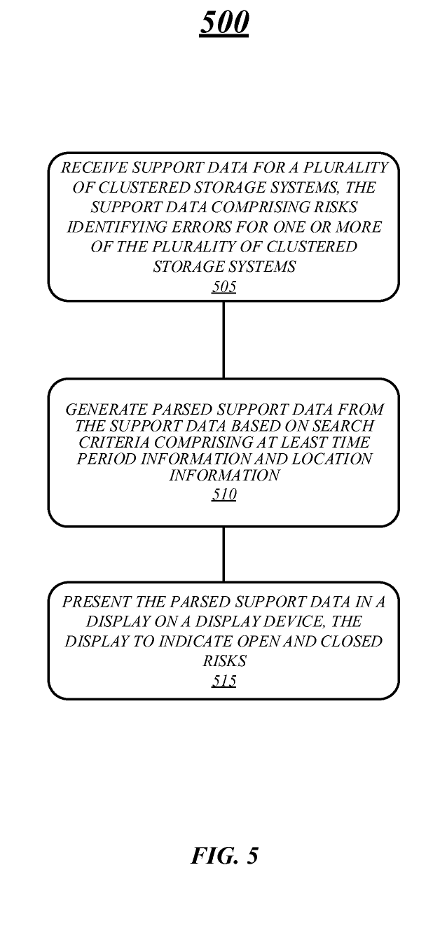

FIG. 5 illustrates an embodiment of logic flow 500. The logic flow 500 may be representative of some or all of the operations executed by one or more embodiments described herein. For example, the logic flow 500 may illustrate operations performed by systems of FIGS. 1A and 1B. However, various embodiments are not limited in this manner.

In the illustrated embodiment shown in FIG. 5, the logic flow 500 may include receiving support data for a plurality of clustered storage systems, the support data comprising risks identifying errors for one or more of the plurality of clustered storage systems at block 505. For example, support data may be received as one or more packets over a wired or wireless communication link. In some instances, the support data may be in a CVS format and includes risk information and system configuration information for each of the clustered storage systems. The risk information includes every known risk or potential problem that can affect one or more of the clustered storage system. Moreover, each risk may be associated with one or more of the clustered storage systems based on whether the particular risk can affect a particular clustered storage system based on a hardware platform, software version, system configuration, and so forth. In other words, a particular risk may be associated with more than one clustered storage system.

In embodiments, at block 510 the logic flow 500 also includes generating parsed support data from the support data based on search criteria comprising at least time period information and location information. In embodiments, the search criteria may be received in a search query generated by a one or more user selections using a GUI. Further, one or more database queries may be generated based on the search criteria to select or gather particular support data to generate the parsed support data, for example. The search criteria can also include a customer identification, a risk level, a service level, a system identification, a software identification, or any other search criteria s previously discussed above.

At block 515, the logic flow 500 includes presenting the parsed support data in a display on a display device, the display to indicate open and closed risks. For example, the parsed support data can be displayed in a graph format as illustrated in FIG. 4A, FIG. 4B, and FIG. 4C. The graph format may display risk information including a number of overall risks and a breakdown of risks by risk level based on the search criteria. In some embodiments, the graph format may present the parsed support data based on a particular search criteria perspective, e.g. by a hardware platform, a software version, a customer, and so forth. For example, the risks displayed in FIG. 4A may be for a particular hardware platform, a particular software version, or a particular customer. Embodiments are not limited in this manner.

The table format can display parsed support data in a different and sometimes more detailed manner. For example, the table format may present the parsed support data with additional information including, a customer identifier, location, serial number, a service level, a host name, and forth. The table format may also be presented based on a specific search criteria such as a hardware platform, a software platform, or a particular customer. Embodiments are not limited in this manner.

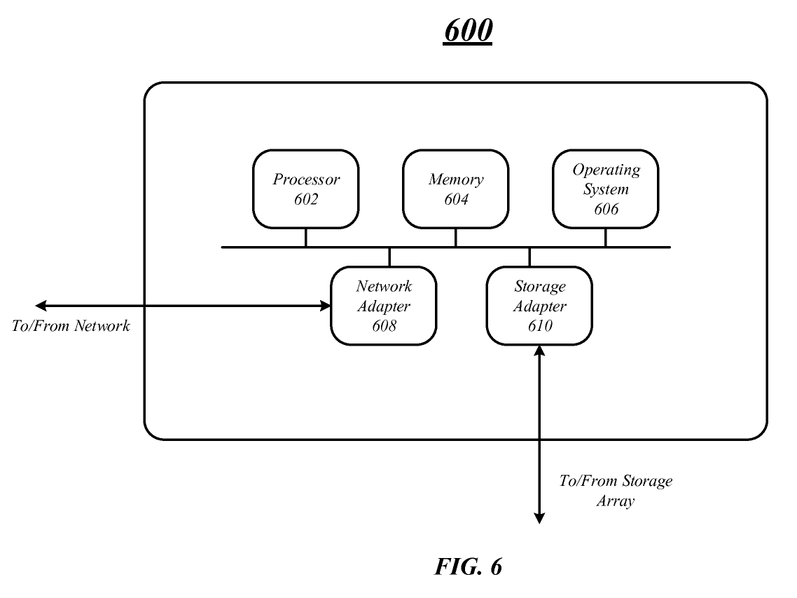

FIG. 6 illustrates an exemplary embodiment of hardware architecture of a system 600, which may be any system illustrated in FIGS. 1A and 1B. System 600 may include processor 602, memory 604, operating system 606, network adapter 608 and storage adapter 610. In various embodiments, the components of system 600 may communicate with each other via one or more interconnects, such as one or more traces, buses and/or control lines.

Processor 602 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. In various embodiments, system 600 may include more than one processor.

In one embodiment, system 600 may include a memory unit 604 to couple to processor 602. Memory unit 604 may be coupled to processor 602 via an interconnect, or by a dedicated communications bus between processor 602 and memory unit 604, which may vary as desired for a given implementation. Memory unit 604 may be implemented using any machine-readable or computer-readable media capable of storing data, including both volatile and non-volatile memory. In some embodiments, the machine-readable or computer-readable medium may include a non-transitory computer-readable storage medium, for example. The embodiments are not limited in this context.

The memory unit 604 may store data momentarily, temporarily, or permanently. The memory unit 604 may store instructions and data for system 600. The memory unit 604 may also store temporary variables or other intermediate information while the processor 602 is executing instructions. The memory unit 604 is not limited to storing the above discussed data; the memory unit 604 may store any type of data. In various embodiments, memory 604 may store or include operating system 606

In various embodiments, system 600 may include operating system 606 to control storage operations on the system 600. In some embodiments, operating system 606 may be stored in memory 604 or any other type of storage device, unit, medium, and so forth. In clustered storage system environments, the operating system 606 may implement a write-anywhere file system that cooperates with virtualization modules to “virtualize” the storage space provided on the storage arrays and storage devices. The file system may logically organize the information as a hierarchical structure of named directories and files on the disks. Each “on-disk” file may be implemented as set of disk blocks configured to store information, such as data, whereas the directory may be implemented as a specially formatted file in which names and links to other files and directories are stored. The virtualization modules allow the file system to further logically organize information as a hierarchical structure of logical data blocks on the disks that are exported as logical unit numbers (LUNs).

The network adapter 608 may include the mechanical, electrical and signaling circuitry needed to connect the system 600 to one or more hosts and other storage systems over a network, which may include a point-to-point connection or a shared medium, such as a local area network.

In various embodiments, the storage adapter 610 cooperates with the operating system 606 executing on the system 600 to access information requested by another system or storage device. The information may be stored on any type of attached array of writable storage device media such as video tape, optical, DVD, magnetic tape, bubble memory, electronic random access memory, micro-electro mechanical and any other similar media adapted to store information, including data and parity information. Further, the storage adapter 610 includes input/output (I/O) interface circuitry that couples to the disks over an I/O interconnect arrangement, such as a conventional high-performance, FC serial link topology.

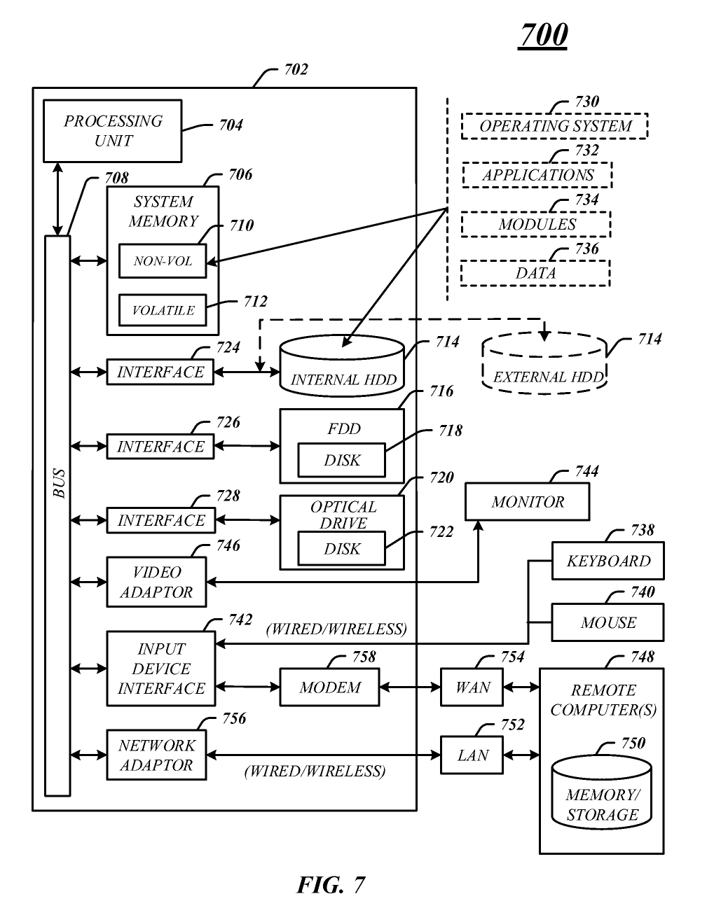

FIG. 7 illustrates an embodiment of an exemplary computing architecture 700 suitable for implementing various embodiments as previously described. In one embodiment, the computing architecture 700 may include or be implemented as part of computing system, such as systems 105, 110, and 115.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 includes a processing unit 704, a system memory 706 and a system bus 708. The processing unit 704 can be any of various commercially available processors.

The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. In one embodiment, the one or more application programs 732, other program modules 734, and program data 736 can include, for example, the various applications and/or components of the system 100.

A user can enter commands and information into the computer 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth

A monitor 744 or other type of display device is also connected to the system bus 708 via an interface, such as a video adaptor 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 702 family of standards, such as wireless devices operatively disposed in wireless communication (e.g., IEEE 702.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 702.11x (a, b, g, n, etc.) to provide secure, reliable, fast wireless connectivity. A Wi-Fi network can be used to connect computers to each other, to the Internet, and to wire networks (which use IEEE 702.3-related media and functions).

The various elements of the system 100 as previously described with reference to FIGS. 1-8 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
memory;
processing circuitry coupled with memory;
a support data component having instructions storable in the memory and operable on the processing circuitry, the support data component to receive support data for a plurality of clustered storage systems, the support data comprising risks identifying errors for one or more of the plurality of clustered storage systems;
an analysis component having instructions storable in the memory and operable on the processing circuitry, the analysis component to generate parsed support data from the support data based on search criteria comprising at least time period information and location information, the search criteria received in a search query; and
a display component having instructions storable in the memory and operable on the processing circuitry, the display component to present the parsed support data in a display on a display device, the display to indicate open and closed risks for one or more clustered storage systems of the plurality of clustered storage systems based on the search criteria.

2. The apparatus of claim 1, the location information comprising at least one of a region, a service area, and a country and the time period information comprising a time period in at least one of days, weeks, and months.

3. The apparatus of claim 1, the search criteria further comprising at least one of a customer identification, a risk level, a service level, a system identification, and a software identification, the search criteria used to update the parsed support data, and the display component to update the display on the display device to present the open and closed risks.

4. The apparatus of claim 1, the display component to present the parsed support data in at least one of a table format and a graph format.

5. The apparatus of claim 1, the analysis component to determine a risk trend over a time period, and the display component to present the risk trend on the display of the display device in a graph format.

6. The apparatus of claim 1, comprising:
an input device coupled with the memory and the processing circuitry, the input device to receive one or more user inputs including search criteria.

7. The apparatus of claim 6, the input device to receive search criteria during run-time, and the display component to update the display to present on the display device based on the received search criteria.

8. The apparatus of claim 1, comprising:
a storage device coupled with the memory and the processing circuitry, the storage device to store the support data in a database having a database format.

9. The apparatus of claim 1, the display component to transform the parsed support data from a database format to at least one of a table format and a graph format for presentation on the display device.

10. The apparatus of claim 1, the open risks comprising unfixed errors and the closed risks comprising fixed errors.

11. An article comprising a computer-readable storage medium comprising a plurality of instructions that, when executed by processing circuitry, enable the processing circuitry to:
receive support data for a plurality of clustered storage systems, the support data comprising risks identifying errors for one or more of the plurality of clustered storage systems;
generate parsed support data from the support data based on search criteria comprising at least time period information and location information, the search criteria received in a search query; and
present the parsed support data in a display on a display device, the display to indicate open and closed risks for one or more clustered storage systems of the plurality of clustered storage systems based on the search criteria.

12. The storage medium of claim 11, the location information comprising at least one of a region, a service area, and a country and the time period information comprising a time period in one of days, weeks, and months.

13. The storage medium of claim 11, the search criteria further comprising at least one of a customer identification, a risk level, a service level, a system identification, and a software identification, the search criteria used to update the parsed support data, and update the display on the display device to present the open and closed risks.

14. The storage medium of claim 11, comprising a plurality of instructions that when executed enable processing circuitry to present the parsed support data in at least one of a table format and a graph format.

15. The storage medium of claim 11, comprising a plurality of instructions that when executed enable processing circuitry to determine a risk trend over a time period, and present the risk trend on the display of the display device in a graph format.

16. The storage medium of claim 11, comprising a plurality of instructions that when executed enable processing circuitry to receive search criteria during run-time, and update the display to present on the display device based on the received search criteria.

17. The storage medium of claim 11, comprising a plurality of instructions that when executed enable processing circuitry to transform the parsed support data from a database format to at least one of a table format and a graph format for presentation on the display device.

18. A computer-implemented method, comprising:
receiving support data for a plurality of clustered storage systems, the support data comprising risks identifying errors for one or more of the plurality of clustered storage systems;
receiving a search query comprising search criteria;
generating parsed support data from the support data based on search criteria comprising at least time period information and location information; and
presenting the parsed support data in a display on a display device, the display to indicate open and closed risks for one or more clustered storage systems of the plurality of clustered storage systems based on the search criteria.

19. The computer-implemented method of claim 18, the location information comprising at least one of a region, a service area, and a country and the time period information comprising a time period in one of days, weeks, and months.

20. The computer-implemented method of claim 18, the search criteria further comprising at least one of a customer identification, a risk level, a service level, a system identification, and a software identification, the search criteria used to update the parsed support data, and update the display on the display device to present the open and closed risks.

21. The computer-implemented method of claim 18, comprising presenting the parsed support data in at least one of a table format and a graph format.

22. The computer-implemented method of claim 18, comprising determining a risk trend over a time period, and presenting the risk trend on the display of the display device in a graph format.

23. The computer-implemented method of claim 18, comprising receiving search criteria during run-time, and update the display to present on the display device based on the received search criteria.

24. The computer-implemented method of claim 18, comprising transforming the parsed support data from a database format to at least one of a table format and a graph format for presentation on the display device.
